(19) United States
(12) Patent Application Publication
(10) Pub. No.: US 2012/0293429 A1
(43) Pub. Date: Nov. 22, 2012

(54) TOUCH SCREEN DEVICE AND METHOD FOR DETECTING TOUCH SIGNALS THEREOF

(76) Inventors: Tzu-Hsien Chuang, Hsin-Chu (TW); Yuan-Ting Fu, Hsin-Chu (TW); Jie-Chuan Huang, Hsin-Chu (TW); Pei-Chen Chan, Hsin-Chu (TW)

(21) Appl. No.: 13/429,421

(22) Filed: Mar. 25, 2012

(30) Foreign Application Priority Data
May 17, 2011 (TW) 100117197

(51) Int. Cl. G06F 3/041

(52) U.S. Cl. 345/173

(57) ABSTRACT

A method for detecting touch signals of a touch screen device includes counting a first time slot and a second time slot of an on-off period of a pixel according to a period of a scan signal and a period of a clock signal, and detecting whether the pixel is touched during the second time slot. The first time slot is the time before a noise of the pixel drops to a predetermined value after the pixel is turned on. The second time slot is the time after the noise of the pixel drops to the predetermined value after the pixel is turned on.

### BACKGROUND OF THE INVENTION

1. Field of the Invention

The present invention relates to a method for detecting touch signals of a touch screen device, and more particularly, to a method for detecting touch signals of the touch screen device according to a noise of a pixel.

2. Description of the Prior Art

Please refer to FIG. 1. FIG. 1 is a diagram showing a capacitive touch screen device 100. The capacitive touch screen device 100 comprises a display panel 110 and a touch panel 120. The touch panel 120 is disposed above the display panel 110 for detecting a touched position. As shown in FIG. 1, when the touch panel 120 is touched, a change of potential between a vertical conductive stripe and a horizontal conductive stripe at the touched position occurs, such that the touched position of the capacitive touch screen device 100 is detected.

Please refer to FIG. 2. FIG. 2 is a diagram showing a waveform of a noise N generated by the display panel 110. When a pixel of the display panel 110 is turned on by a scan signal Y, the noise N at the turned-on pixel maybe generated by a common voltage of the display panel 110 or by other reasons. The noise N effects a sensing function of the touch panel and even causes misjudgments.

### SUMMARY OF THE INVENTION

The present invention provides a method for detecting touch signals of a touch screen device comprising counting a first time slot and a second time slot of an on-off period of a pixel according to a period of a scan signal and a period of a clock signal, and detecting whether the pixel is touched during the second time slot. The first time slot is the time before a noise of the pixel drops to a predetermined value after the pixel is turned on. The second time slot is the time after the noise of the pixel drops to the predetermined value after the pixel is turned on.

The present invention further provides a method for detecting touch signals of a touch screen device comprising turning on a pixel of the touch screen device via a scan line, measuring a noise of the pixel generated by a common voltage, and detecting whether the pixel is touched when the noise of the pixel generated by the common voltage drops to a predetermined value.

A touch screen device of the present invention is disclosed. The touch screen device comprises a display panel and a touch panel. The display panel comprises a plurality of pixels arranged in a matrix form, a plurality of data lines for transmitting display data, a plurality of scan lines for transmitting scan signals for controlling the plurality of pixels to receive the display data, and a clock for providing a clock signal. The touch panel comprises a sensing panel for detecting a touched position, and a controller electrically connected to the display panel and the sensing panel for counting a first time slot and a second time slot of an on-off period of the pixel according to a period of the scan signal and a period of the clock signal, and for detecting whether the pixel is touched during the second time slot. The first time slot is the time before the noise of the pixel drops to a predetermined value after the pixel is turned on. The second time slot is the time after the noise of the pixel drops to the predetermined value after the pixel is turned on.

Another embodiment of the touch screen device of the present invention comprises a display panel and a touch panel. The touch panel comprises at least one pixel for displaying, a plurality of data lines for transmitting display data, a plurality of scan lines for transmitting scan signals for controlling the at least one pixel to receive the display data, and a measurement unit for measuring a noise of the at least one pixel generated by a common voltage. The touch panel comprises a sensing panel for detecting a touched position, and a controller electrically connected to the display panel and the sensing panel for detecting whether the pixel is touched when the noise of the at least one pixel generated by the common voltage drops to a predetermined value.

The other embodiment of the touch screen device of the present invention comprises a display panel and a touch panel. The touch panel comprises at least one pixel for displaying, a plurality of data lines for transmitting display data, a plurality of scan lines for transmitting scan signals for controlling the at least one pixel to receive the display data, a clock for providing a clock signal, and a first controller for counting a first time slot and a second time slot of an on-off period of the pixel according to a period of the scan signal and a period of the clock signal and for generating a look-up table according to the first time slot and the second time slot. The first time slot is the time before the noise of the pixel drops to a predetermined value after the pixel is turned on. The second time slot is the time after the noise of the pixel drops to a predetermined value after the pixel is turned on. The touch panel comprises a sensing panel for detecting a touched position, and a controller electrically connected to the display panel and the sensing panel for detecting whether the at least one pixel is touched during the second time slot according to the look-up table.

The other embodiment of the touch screen device of the present invention comprises a display panel and a touch panel. The touch panel comprises at least one pixel for displaying, a plurality of data lines for transmitting display data, and a plurality of scan lines for transmitting scan signals for controlling the at least one pixel to receive the display data during an on-off period. Wherein the on-off period comprises a first time slot and a second time slot, and the first time slot is the time before the noise of the pixel drops to a predetermined value after the pixel is turned on, the second time slot is the time after the noise of the pixel drops to a predetermined value after the pixel is turned on. The touch panel comprises a sensing panel for detecting a touched position, and a first controller electrically connected to the display panel and the sensing panel for controlling the sensing panel to detect whether the sensing panel is touched during the second time slot.

The other embodiment of the touch screen device of the present invention comprises a display panel and a touch sensing element and a first controller. The touch panel comprises at least one pixel for displaying, a plurality of data lines for transmitting display data, and a plurality of scan lines for transmitting scan signals for controlling the at least one pixel to receive the display data during an on-off period. Wherein the on-off period comprises a first time slot and a second time slot, and the first time slot is the time before the noise of the pixel drops to a predetermined value after the pixel is turned on, the second time slot is the time after the noise of the pixel drops to a predetermined value after the pixel is turned on. The touch sensing element is for detecting a touched position. The first controller electrically connected to the display panel and the touching sensing element for controlling the touch sensing element to detect whether the touch sensing element is touched during the second time slot.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a capacitive touch screen device.

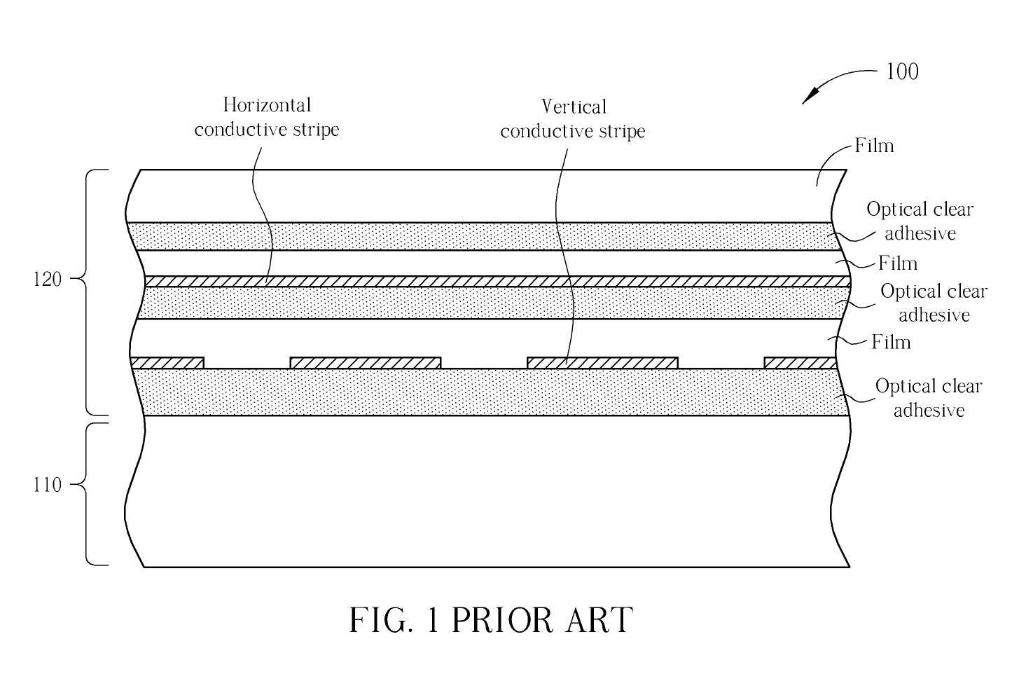

FIG. 2 is a diagram showing a waveform of a noise generated by a display panel.

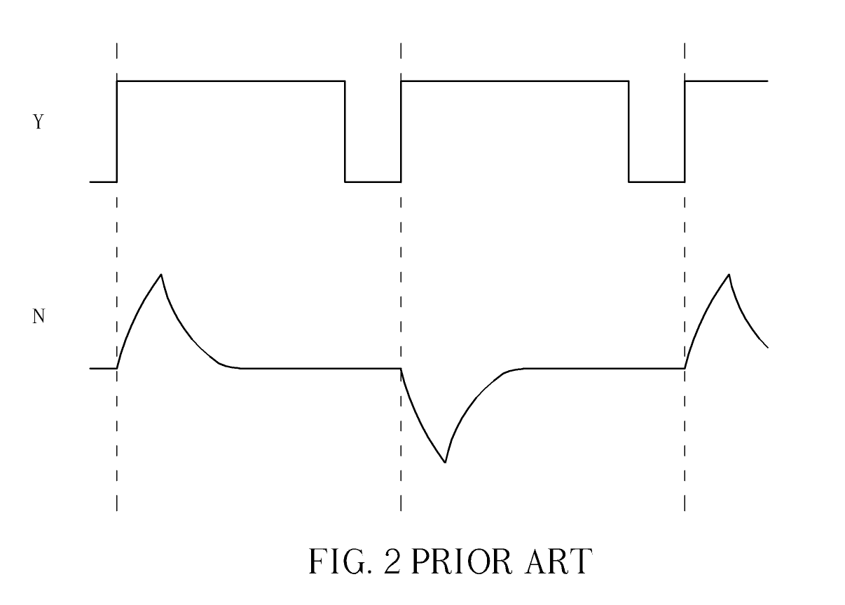

FIG. 3 is a diagram showing a capacitive touch screen device of a first embodiment of the present invention.

FIG. 4 is a diagram showing a waveform of a noise generated by a display panel of the present invention.

FIG. 5 is a diagram showing a capacitive touch screen device of a second embodiment of the present invention.

FIG. 6 is a diagram showing a capacitive touch screen device of a third embodiment of the present invention.

FIG. 7 is a flowchart showing a method for detecting touch signals of a touch screen device of the present invention.

FIG. 8 is a flowchart showing another method for detecting touch signals of a touch screen device of the present invention.

### DETAILED DESCRIPTION

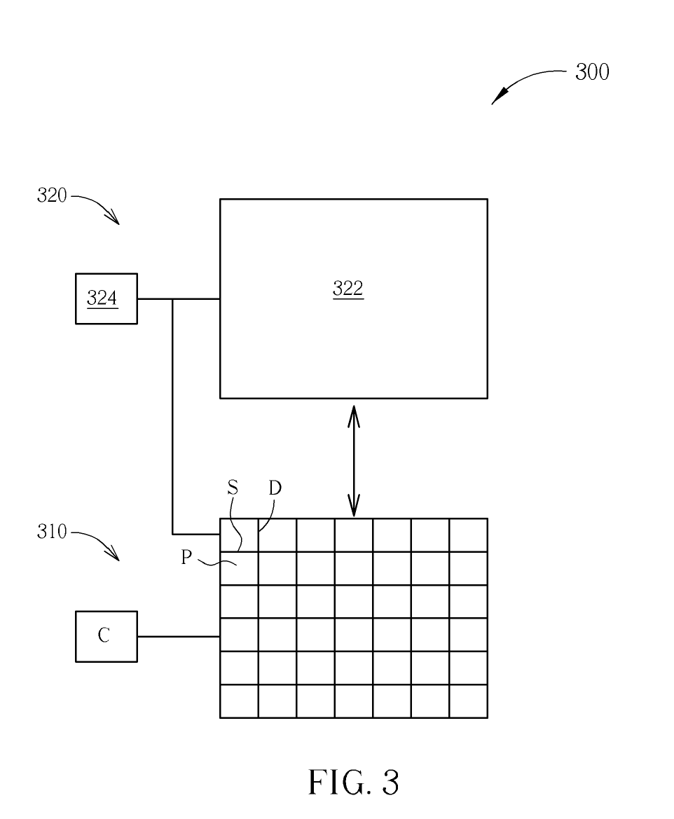

Please refer to FIG. 3. FIG. 3 is a diagram showing a capacitive touch screen device 300 of a first embodiment of the present invention. The capacitive touch screen device 300 of the present invention comprises a display panel 310 and a touch panel 320. The display panel 310 comprises a plurality of pixels P arranged in a matrix form, a plurality of data lines D for transmitting display data, a plurality of scan lines S for transmitting scan signals for controlling the pixels P to receive the display data, and a clock C for providing a clock signal. The touch panel 320 comprises a sensing panel 322 disposed above the display panel 310, and a controller 324. The sensing panel 322 is for detecting a touched position. The controller 324 is electrically connected to the display panel 310 and the sensing panel 322 for detecting whether the sensing panel 322 is touched.

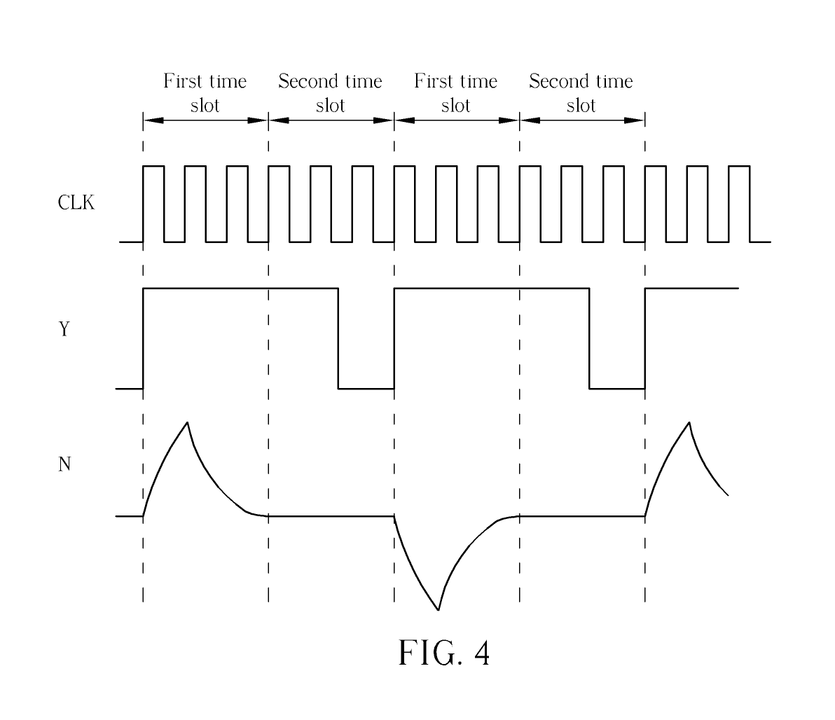

Please refer to FIG. 4. FIG. 4 is a diagram showing a waveform of a noise generated by the display panel 310 of the present invention. As shown in FIG. 4, when a voltage level of a scan signal Y is pulled up to turned on the pixel P, the pixel P receives an input voltage, and a common voltage of the display panel 310 generates a noise N at the turned-on pixel P. In order to avoid the noise N generated by the common voltage, the controller 324 counts a first time slot and a second time slot of an on-off period of the pixel P according to a period of the scan signal Y and a period of a clock signal CLK. Since the period of the clock signal CLK is a basic time unit of related signals, the first time slot and the second time slot are multiples of the period of the clock signal. The first time slot is the time before the noise N drops to a predetermined value after the pixel P is turned on and the second time slot is the time after the noise N drops to a predetermined value after the pixel P is turned on. Since a plurality of pixels are updated within a frame time (a time in which all pixels of the display panel are turned on sequentially), a frame time comprises a plurality of second time slots. The controller 324 can detect whether each pixel P is touched during the second time slot of each pixel P, or detect whether the pixels of a specific row are touched during the second time slot of the pixels P of the specific row. Therefore, the method of the present invention can avoid the noise N of the common voltage during the detection. And, the detection is completed within a frame time, which is faster than performing the detection after displaying a frame completely.

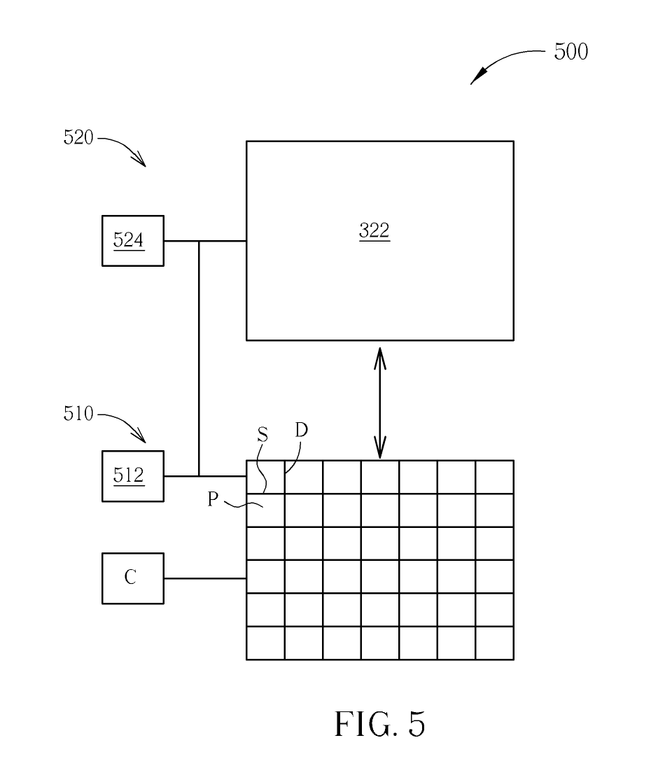

Please refer to FIG. 5. FIG. 5 is a diagram showing a capacitive touch screen device of a second embodiment of the present invention. Different from the first embodiment, a display panel 510 further comprises a measurement unit 512 electrically connected to the controller 524 of the touch panel 520 for measuring the noise N of the pixel P generated by the common voltage. A controller 524 of a touch panel 520 determines whether the noise N of the common voltage drops to a predetermined value according to the sensed voltage level of the noise N of the common voltage from the measurement unit 512. When the noise of the pixel P generated by the common voltage drops to the predetermined value, the controller 524 starts to detect whether the pixel P is touched, so as to avoid the noise N of the common voltage during detection.

Another embodiment corresponding to FIG. 5 is the measurement unit 512 may cooperate with a memory (not shown) and a counter (not shown). The measurement unit 512 observers the noise N of the pixel P generated by the common voltage while the counter counting the number (times) of pulses of the clock signal CLK generated by the clock C before the noise N of the pixel P drops to a predetermined value after the pixel P is turned on. As the result, the number(times) of pulses of the clock signal CLK corresponding to the first time slot can be store in the memory. With the stored information, the controller 524 of the touch panel 520 can recognize the first time slot and the second time slot according to the stored information in the memory. The controller 524 can start to control the touch panel 520 to detect whether the pixel P is touched after the number(times) of pulses of the clock signal corresponding to the first time slot is generated by the clock C after the pixel P is turned on.

For example, if the counter once counting there are 5 pulses of the clock signal CLK is generated before the noise N of the pixel P drops to a predetermined value after the pixel is turned on, the controller 524 can start to control the touch panel 520 to detect whether the pixel P is touched after 5 pulses of the clock signal CLK is generated after the pixel P is turned on next time.

Moreover, the measurement procedure can be performed when the display is manufactured or when the display is used by customer and the stored information in the memory may be refreshed if necessary. The memory may also store other types of information to indicate the first time slot and the second time slot.

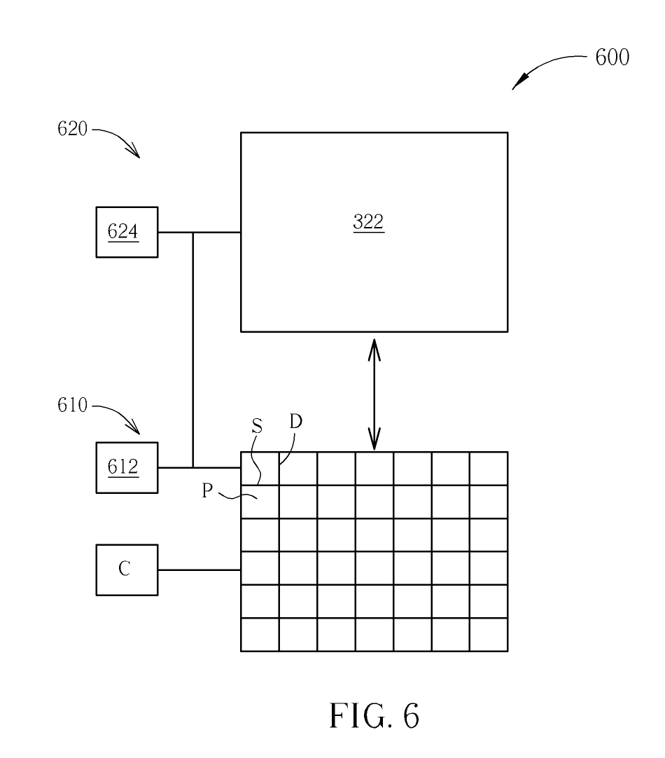

Please refer to FIG. 6. FIG. 6 is a diagram showing a capacitive touch screen device of a third embodiment of the present invention. Different from the above embodiments, a display panel 610 further comprises a controller 612 for generating a look-up table according to the first time slot and the second time slot of each pixel P. A controller 624 of a touch panel 620 can obtain timing information of the first time slot and the second time slot of each pixel P from the look-up table, and then detects whether each pixel P is touched during the second time slot of each pixel P, so as to avoid the noise N of the common voltage during detection. Moreover, the look-up table can be stored in a memory (not shown).

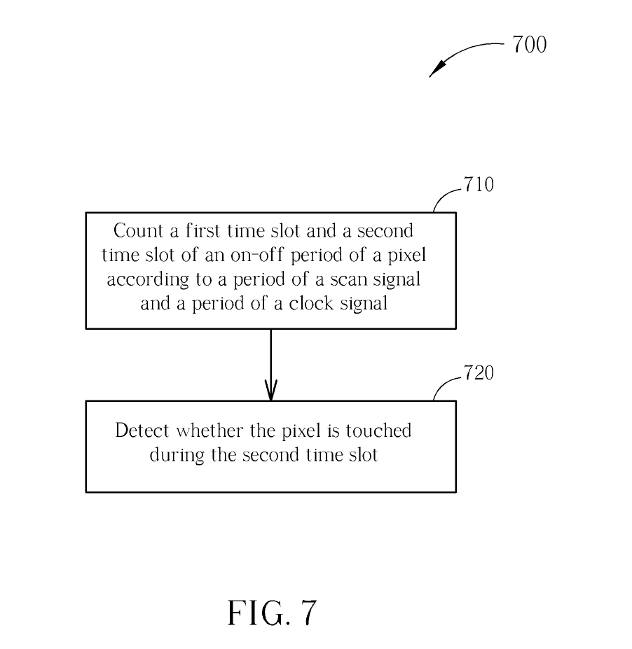

Please refer to FIG. 7. FIG. 7 is a flowchart 700 showing a method for detecting touch signals of a touch screen device of the present invention. The method for detecting touch signals of the touch screen device of the present invention comprises the following steps:

Step 710: Count/determine/provide a first time slot and a second time slot of an on-off period of a pixel according to a period of a scan signal and a period of a clock signal; and

Step 720: Detect whether the pixel is touched during the second time slot.

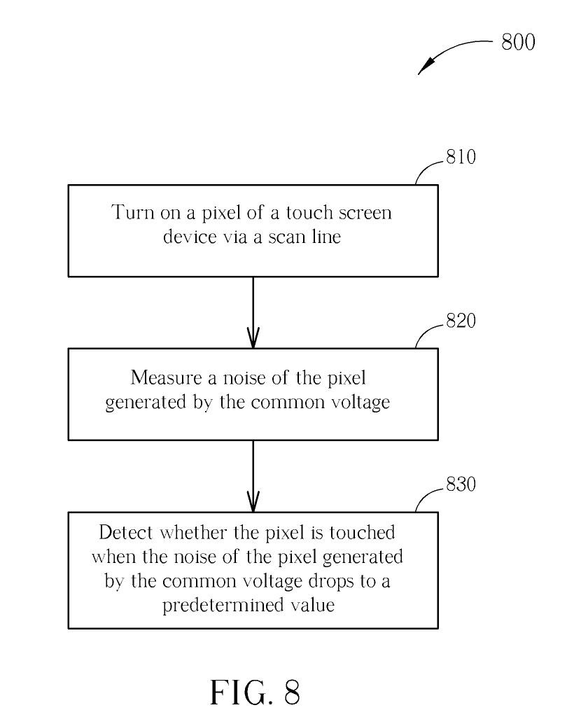

Pease refer to FIG. 8. FIG. 8 is a flowchart 800 showing another method for detecting touch signals of a touch screen device of the present invention. The method for detecting touch signals of the touch screen device of the present invention comprises the following steps:

Step 810: Turn on a pixel of a touch screen device via a scan line;

Step 820: Measure a noise of the pixel generated by the common voltage; and

Step 830: Detect whether the pixel is touched when the noise of the pixel generated by the common voltage drops to a predetermined value.

In addition, the above embodiments are only for illustrating the method of detecting touch signals of the touch screen device of the present invention. The touch screen device of the present invention is not limited to the above three embodiments. Any method for detecting touch signals of a touch screen device according to the above steps should be included within the scope of the present invention. Furthermore, the display panel of the touch screen device of the present invention can be a liquid crystal display panel, or an Organic Light-Emitting Diode (OLED) display panel, etc. The touch panel of the touch screen device of the present invention is configured to be a touch sensing element, such as a capacitive touch panel, a photo-sensor touch panel, an electric field touch panel, a resistance touch panel. Furthermore, A capacitive touch sensor, a photo touch sensor, an electric field touch sensor, a resistance touch sensor can also be configured to perform the function of a touch sensing element. Moreover, the touch sensing element can be configured on the display panel or integrated with the display panel. In other word, The touch sensing element can be configure on a substrate disposed on the display panel or be embedded in the display panel.

In the above embodiments, the touch panel is a capacitive touch panel as an example, not for restriction present invention.

In contrast to the prior art, the method for detecting touch signals of a touch screen device of the present invention can avoid the noise generated by the common voltage in order to detect the touch signals of the touch screen device more precisely. The touch screen device of the present invention does not need an additional shielding layer to avoid the noise, so as to simplify manufacturing processes of the touch screen device and increase yield rate of the touch screen device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting touch signals of a touch screen device, comprising:
providing an on-off period of a pixel according to a scan signal, wherein the on-off period of the pixel comprises a first time slot and a second time slot, the first time slot is the time before a noise of the pixel drops to a predetermined value after the pixel is turned on, and the second time slot is the time after the noise of the pixel drops to the predetermined value after the pixel is turned on; and
detecting whether the pixel is touched during the second time slot.

2. The method of claim 1, wherein the first time slot and the second time slot are multiples of a period of a clock signal.

3. The method of claim 1, further comprising generating a look-up table according to the first time slot and the second time slot, wherein the step of detecting whether the pixel is touched during the second time slot is according to the look-up table.

4. The method of claim 1, wherein the noise of the pixel is generated by a common voltage.

5. The method of claim 1, further comprising measuring the noise after the pixel is turned on.

6. The method of claim 5, further comprising storing a parameter corresponding to a measuring result.

7. The method of claim 6, wherein the step of storing the parameter corresponding to the measuring result is storing number of pulses of a clock signal before the noise of the pixel drops to the predetermined value after the pixel is turned on.

8. The method of claim 5, further comprising counting the number of pulses of a clock signal before the noise of the pixel drops to the predetermined value after the pixel is turned on.

9. The method of claim 1, wherein the step of detecting whether the pixel is touched is performed within a frame time.

10. The method of claim 1, further comprising storing a time slot parameter corresponding to the first time slot and the second time slot.

11. The method of claim 1, wherein a plurality of detections are performed within a frame time.

12. A touch screen device, comprising:
a display panel, comprising:
at least one pixel for displaying;
a plurality of data lines for transmitting display data; and
a plurality of scan lines for transmitting scan signals for controlling said at least one pixel to receive the display data during an on-off period, wherein the on-off period comprises a first time slot and a second time slot, wherein the first time slot is the time before the noise of the pixel drops to a predetermined value after the pixel is turned on, the second time slot is the time after the noise of the pixel drops to a predetermined value after the pixel is turned on;
a touch sensing element for detecting a touched position; and
a first controller electrically connected to the display panel and the touch sensing element for controlling the touch sensing element to detect whether the touch sensing element is touched during the second time slot.

13. The touch screen device of claim 12, wherein the display panel further comprises a measurement unit electrically connected to the first controller for measuring the noise after the pixel is turned on.

14. The touch screen device of claim 12, wherein the first controller further determines the on-off period of the pixel according to the scan signal.

15. The touch screen device of claim 14, wherein the display panel further comprises a measurement unit electrically connected to the first controller for measuring the noise after the pixel is turned on.

16. The touch screen device of claim 12, wherein the touch sensing element is a capacitive touch panel, a photo-sensor touch panel, an electric field touch panel, a resistance touch panel, a capacitive touch sensor, a photo touch sensor, an electric field touch sensor, or a resistance touch sensor.

17. The touch screen device of claim 12, wherein the display panel further comprising a second controller for determining the on-off period of the pixel according to the scan signal, and for generating a look-up table according to the first time slot and the second time slot; and the first controller controls the sensing panel to detect whether the pixel is touched during the second time slot according to the look-up table.

18. The touch screen device of claim 17, wherein the noise of the pixel is generated by a common voltage.

19. The touch screen device of claim 12, further comprises a substrate disposed on the display panel, and the touch sensing element is configured on the substrate.

20. The touch screen device of claim 12, the touch sensing element is integrated with the display panel.
